(19) United States
(12) Patent Application Publication
(10) Pub. No.: US 2021/0138729 A1
(43) Pub. Date: May 13, 2021

(54) Method For Generative Building Of Shaped Bodies By Stereolithography

(71) Applicants: Ivoclar Vivadent AG, Schaan (LI); Technische Universität Wien, Wien (AT)

(72) Inventors: Hendrik John, Buchs SG (CH); Jörg Ebert, Buchs (CH); KaI Rist, Feldkirch (AT); Sonja Baumgartner, Wien (AT); Malte Hartmann, Wien (AT)

(21) Appl. No.: 17/068,918

(22) Filed: Oct. 13, 2020

(30) Foreign Application Priority Data
Nov. 8, 2019 (EP) 19207967.1

(51) Int. Cl. B29C 64/214; B33Y 10/00; B33Y 70/00; B28B 1/00; B29C 64/124; B33Y 30/00; B29C 64/255

(52) U.S. Cl. CPC B29C 64/214; B33Y 10/00; B33Y 70/00; B29K 2105/0032; B29C 64/124; B33Y 30/00; B29C 64/255; B28B 1/001

(57) ABSTRACT

The present invention relates to a method for building a shaped body by layer-wise solidification of photopolymerizable building material by means of stereolithography characterized in that the positioning of a blade with respect to a vat bottom is adjusted in such a manner that the resulting predetermined, uniform layer thickness is higher than the predefined layer thickness to be set by lowering a building platform, but does not exceed the predefined layer thickness by more than 50%.

### CROSS-REFERENCE TO RELATED APPLICATIONS

This application claims priority to European patent application No. 19207967.1 filed on Nov. 8, 2019, the disclosure of which is incorporated herein by reference in its entirety.

### TECHNICAL FIELD

The present invention relates to a method for generative building of shaped bodies by layer-wise solidification of viscous, photopolymerizable building material by means of stereo-lithography.

The building material may be a ceramic slurry on an organic basis—i.e. a flowable, photopolymerizable material which is filled with ceramic particles, wherein the viscosity is increasing with increasing amount of ceramic particles—or may consist of highly viscous, light-curing composites or photopolymers. When using ceramic slurries as building material a green body is generated as the shaped body, which green body is then further processed by debinding and sintering to a ceramic body. The present invention is in particular applicable in the field of production of dental restorations.

### BACKGROUND

In order to achieve aesthetically satisfying results for dental restorations it is often desired to work with varying building materials in a position dependent manner and/or to work with varying colorings in a location-dependent manner. With conventional stereolithography processes for layer-wise building up green bodies from ceramic slurry it is known that the body which is in the process of being built is moved, after solidifying the current layer, out of the building area and that photopolymer including pigments is selectively applied using an ink jet printing method to the last cured layer. Such a process is for example known from WO 2013/182547 A1 and corresponding U.S. Pat. No. 9,592,635, which is hereby incorporated by reference in its entirety, in which a drum-shaped carrier is used on which four building platforms are arranged around its circumference in 90° distance to each other. Working stations are distributed around the drum-shaped carrier likewise in 90° distances. Among the working stations are a vat having a transparent bottom under which an exposure unit is located, an ink jet printer for printing photopolymer being filled with pigments onto the last cured layer, and a further exposure unit for solidifying the spatially selectively imprinted pigment filled photopolymer. The drum-shaped carrier is mounted to be rotatable such that a respective one of the building platforms is in the region of one of the working stations and is processed therein. After completion of the working steps in the respective working stations the drum-shaped carrier is rotated by 90° so that on a respective part on a building platform the next working step can be carried out in the next work station. Although in this process working steps can be carried out in parallel on parts on several building platforms, the process is very time consuming, wherein a lot of time is spent during the mechanical movement of the building platform between the working stations.

Alternatively different materials can be used for forming a layer, which different materials are held ready in different vats. Then the building platform is subsequently lowered into different vats in order to successively solidify subareas of the layer to be cured with different building materials in the different vats. Such a process is described in DE 10 2007 010 624 B4. To avoid cross-contamination (transfer of an amount of building material into a vat with different building material) it is necessary to clean the part after the building platform has been lifted up with the part hanging thereon, before the part is lowered into another building material in the next vat. Therefore, it is necessary for each change of building material to perform a cleaning procedure which makes also this method time consuming. In addition, also the transport necessary for changing between different vats is time consuming.

US 2014044824 and US 20180141268 are directed to stereolithography and are hereby incorporated by reference in their entirety.

DE 10 2011 117 005 B4 relates to a method for manufacturing of a ceramic dental restoration based on a generative manufacturing method in which single slurry layers are successively deposited and solidified layer by layer. After depositing a slurry layer, the layer thickness of this layer is reduced by a doctor blade which also results in a smoothed layer, whereafter a spatially selective deposition of an ink-liquid is performed. This ink contains, besides coloring agents, also an initiator which triggers the chemical reaction causing the solidification of the slurry layer so that coloring and solidification take place simultaneously.

U.S. Pat. No. 9,975,323 B2, which is hereby incorporated by reference in its entirety, relates generally to generative 3D print methods, wherein also generative methods are mentioned in which a liquid in a vat is solidified in a spatially selective manner by a laser or another energy source. The described method particularly emphasizes that layers are formed selectively on top of each other, wherein the volume created by the layers on top of each other consists of a plurality of columns lying adjacent to each other, each column consisting of a plurality of voxel elements or voxels (volume pixels) lying one above the other, wherein in each column the coloring/transparency of each of the voxel elements is created in a selective manner. No specific details regarding the individual coloring of the single voxel elements and the individual color application for each voxel element are described.

EP 2 337 667 B1 and corresponding U.S. Pat. Nos. 8,623,264B2 and 9,067,359, both of which are hereby incorporated by reference in their entirety, disclose a method in which a viscous, photopolymerizable building material is dispensed onto a planar, transparent bottom of a vat. A doctor blade is suspended with adjustable positioning above the vat bottom. The vat is moved, in a direction parallel to the plane of the vat bottom, relative to the doctor blade so that dispensed building material is pushed to move underneath and past the doctor blade, whereby a smoothed layer is formed having a uniform layer thickness predetermined by the positioning of the doctor blade with respect to the vat bottom. This may for example be accomplished by rotating the vat about an axis of rotation which is perpendicular to the vat bottom so that the vat bottom is moved underneath the non-rotating doctor blade. Dispensed building material is accumulating upstream of the doctor blade and only some of the accumulated building material passes the gap underneath the doctor blade so that this passing building material is formed into a smoothed layer of predetermined, uniform layer thickness. The smoothed layer is, by relative movement of the vat, moved to a region between an exposure unit located below the vat bottom and a building platform suspended above the vat in a height-adjustable manner. Thereafter, the building platform is lowered with respect to the vat bottom in a precisely controlled manner while displacing building material from the smoothed layer, so that the remaining layer in the clearance between the building platform and the vat bottom is set to a predetermined layer thickness which is determined by the distance of the lower surface of the building platform (or the lower surface of the last cured layer) to the vat bottom. In this manner the predetermined layer thickness can be set with high precision. Thereafter, the layer with the predetermined layer thickness is solidified by exposure in a spatially selective manner by controlled operation of the exposure unit to effect exposure within the desired contour of the current layer to be solidified. Finally, the building platform is raised, building material is dispensed onto the vat bottom, and the above described steps are repeated, until the shaped body has been formed by a plurality of layers selectively solidified on top of each other.

### SUMMARY

It is an object of the present invention to provide a method of the above described type that can be executed in such a manner so that it can be carried out quickly and precisely also for building materials of high viscosity. It would also be desirable if the successively solidified layers of the shaped body could be colored in a spatially selective manner.

This object is achieved by the method comprising the features of the claims. Preferred embodiments are set out in the dependent claims.

Accordingly, a method is provided for building a shaped body by layer-wise solidification of viscous, photopolymerizable building material by means of stereolithography, wherein

a) building material is dispensed onto a planar, transparent bottom of a vat,

b) the vat is moved relatively to a blade such as a doctor blade in a direction parallel to the plane of the vat bottom, which doctor blade is suspended with adjustable positioning above the vat bottom, such that dispensed building material is moved underneath the doctor blade, to thereby form a smoothed layer having uniform layer thickness predetermined by the positioning of the doctor blade relative to the vat bottom,

c) the smoothed layer is brought by relative movement of the vat to a region between an exposure unit located underneath the vat bottom and a building platform suspended above the vat adjustable in height,

d) the building platform is lowered relative to the vat bottom in a controlled manner so that, while displacing building material, the remaining layer in the gap is formed into a predefined layer thickness,

e) the layer is solidified in a spatially selective manner by controlled operation of the exposure unit within a contour desired for the current layer,

f) whereafter the building platform is raised, building material is dispensed onto the vat bottom, and steps b) to f) are repeated until the shaped body is built up by a plurality of layers solidified on top of each other.

According to the invention the positioning of the doctor blade with respect to the vat bottom is adjusted so that the resulting predetermined, uniform layer thickness is larger than the predefined layer thickness to be set by lowering the building platform, but does not exceed this predefined layer thickness by more than 50%. In other words the building material dispensed on the vat bottom has, by relative movement with respect to the doctor blade suspended above the vat bottom with adjusted positioning, already been formed into a layer having a predetermined, uniform layer thickness which is larger than, but already close to (at most 50% higher than) the predefined layer thickness which is to be set by lowering the building platform.

It is advantageous when the layer thickness, as determined by the positioning of the doctor blade with respect to the vat bottom, is to a certain degree exceeding the predefined layer thickness as to be set by the building platform, because in this way it is ensured that in any case, even if inaccuracies or tolerances in the definition of the predetermined layer thickness by the doctor blade occurred (in particular local shortfall of the predetermined layer thickness), that everywhere in the area of the layer to be defined there is sufficient building material so that everywhere the predefined layer thickness can still be set by lowering the building platform. In other words, everywhere sufficient building material is present so that the lower surface of the building platform (or the lower surface of the last cured layer) over the entire area contacts building material when the gap to the vat bottom is set to the predefined layer thickness. For many building materials, in particular those having low or medium viscosity values, the predetermined, uniform layer thickness can be realized over the entire area of the layer without any problems. For building materials with higher viscosity values there may be a certain variation of the actual layer thickness over the area of the layer so that the actual layer thickness values as a function of the position in the area of the layer are in fact a distribution of layer thickness values, which distribution is very narrow and has a very small full width at half maximum around the average layer thickness. In such cases the “predetermined, uniform layer thickness” is considered as the average layer thickness of the thickness distribution; also in such cases the designation “uniform layer thickness” is justified and technically meaningful since the standard deviation of the thickness distribution is in any case small compared to the average layer thickness. In such cases it is preferred that the predetermined, uniform (average) layer thickness is set to be a little bit higher than the predefined layer thickness to be set by lowering the building platform, for example larger by three standard deviations of the distribution, so that practically at all positions over the area of the layer the building platform, when it is lowered to the predefined layer thickness to be set, gets in contact with building material. Alternatively, the predetermined layer thickness may also be closer to the predefined layer thickness, and a compensation of potential variations of the layer thickness over the area may be achieved by displacing building material in lateral direction when the building platform is lowered.

Due to the fact that the building material is formed by the doctor blade into a layer having a very low, predetermined layer thickness which exceeds the predefined layer thickness by at most 50%, it is ensured that the predetermined, uniform layer thickness formed by the doctor blade is already close to the predefined layer thickness to be set by the building platform, and that as a result only a small amount of building material has to be displaced from the gap when the building platform is lowered towards the vat bottom. In this connection it has to be taken into account that when using high viscosity building material, high forces are needed for lowering the building platform and for displacing building material from the remaining gap from which high viscosity building material has to be displaced. If the maximum force that can be applied is limited by the vat material (for example to avoid breaking or other failure of the vat bottom) the building platform has to be lowered slowly in order to limit the force. For this reason the lowering of the building platform for setting the predefined layer thickness takes a long time for high viscosity building materials. Conversely the reduction of the maximum amount of building material to be displaced reduces the time needed for that. A tight limitation of the maximum amount of building material to be displaced as a result of forming the dispensed building material by the doctor blade into a layer of uniform, predetermined layer thickness of at maximum 150% of the predefined layer thickness to be set by the building platform, therefore allows to quickly set the layer thickness by lowering the building platform, and thus allows a shorter cycle time.

A low amount of building material to be displaced when setting the predefined layer thickness by the building platform has the further advantage that after solidification of a layer lower separation forces for lifting up the building platform are needed compared to situations in which larger amounts of building material have been displaced for setting the predefined layer thickness. When lifting up the building platform the required separation forces have to overcome a negative pressure because the volume which is created between the lower surface of the part being built and the vat bottom when lifting the building platform has to be filled by inflowing air. In case of a large amount of displaced building material, this displaced material forms a barrier around the building platform and the part being built, which barrier obstructs the flow of environmental air into the growing volume above the vat bottom when the building platform is raised. By minimizing the amount of displaced building material inflow of air into the growing volume above the vat bottom is improved, and thereby the separation forces for lifting up the building platform are reduced.

If lowering the building platform for setting the predefined layer thickness causes displacement of large amounts of building material, this has also negative effects on the precision of the dimensions of parts built up by stereolithography, in particular on the precision in z direction (direction perpendicular to the plane of the vat bottom). In a “bottom-up” process, as in the case of the present invention, the layer to be solidified is sandwiched between the building platform (or the lower surface of the part being built if already one or more layers have been solidified) and the vat bottom surface. The height of this gap determines the predefined layer thickness of the layer to be solidified. In this area the maximum curing depth is determined by the gap height (predefined layer thickness), even if the penetration depth of the light at the chosen exposure parameters (intensity and exposure time) and depending on the building material would cause a deeper curing depth. In case that the layer currently to be solidified projects in lateral direction beyond the last layer cured before, building material displaced during setting the layer thickness of the currently to be solidified layer also reaches those portions in which the layer currently to be solidified projects beyond the last cured layer which results in a two large amount of material and a two high layer thickness in this laterally projecting portions of the layer currently to be solidified. Since the actual curing depth of the exposure is always larger than the predefined layer thickness, in these portions solidification of material occurs beyond the predefined layer thickness in z direction in depth regions of the last solidified layer, which may lead a deteriorated precision (oversize) in z direction in an order of magnitude of several layer thicknesses. The minimization of displaced building material, or in other words the optimal approximation of the predetermined layer thickness by the doctor blade to the predefined layer thickness to be set by the building platform, therefore also results in an improved precision of the part to be built. Generally, it is advantageous to keep the amount of displaced building material as low as possible, by letting the predetermined layer thickness, as determined by the positioning of the doctor blade, approximate the predefined layer thickness to be set by the building platform.

At the end of the building process there is always some displaced, excessive and not cured building material on the part built. Thus, there is a need for a cleaning procedure, in particular when the part is to be subjected to thermal post-processing steps such as debinding and sintering. In the context of generative manufacturing processes cleaning procedures are not trivial. For parts with complicated shapes tiny gaps or cavities are accessible for cleaning liquids under considerable efforts only. Furthermore, solvents with good capability to remove monomer mixtures may under certain circumstances damage the surface of the parts, and in case of suspensions (slurries) particulate filler materials may remain on the surface. By keeping the amount of displaced building material during the building process as low as possible, also the amount of excessive building material eventually adhering on the part may be kept as low as possible which alleviates the complications of the cleaning procedures. These aspects are of relevance all the more if the part is built with different materials and the part changes between vats with different building materials during the building process because in such cases cleaning has to be performed in principle upon each material change before the part being built is transferred to the next vat with another building material. In case of a substantial minimization of the amount of building material which is displaced upon setting the layer thickness, cleaning upon material changes may be omitted if a minor contamination by small residues of adhering building material on the part which then comes in contact with another building material in the next vat can be accepted.

Preferably, the positioning of the doctor blade with respect to the vat bottom is adjusted such that the resulting predetermined, uniform layer thickness is in the range of 110 to 130% of the predefined layer thickness to be set by lowering the building platform.

In a preferred embodiment the relative movement of vat and doctor blade with respect to each other is effected by rotating the vat about an axis of rotation which is centered on and perpendicular to the vat bottom while keeping the doctor blade suspended stationary, or by rotating the doctor blade about the axis mentioned in relation to a vat kept stationary. In case of a stationary doctor blade and a rotatable vat the vat bottom can have the shape of a circular disk, with the axis of rotation extending through the center of the disk. The stationary doctor blade has a direction component oriented radially with respect to the axis of rotation and extends from a point radially closest to the axis of rotation radially in outward direction.

In a preferred embodiment the positioning of the doctor blade above the vat bottom is defined by a straight line coinciding with the lower edge of the doctor blade. This straight line has a minimal distance to the vat bottom at a point closest to the rotational axis in radial direction of the lower edge of the doctor blade. The positioning of the straight line is further defined by a sloping angle which is defined between the straight line and a plane parallel to vat bottom which is intersected by the straight line, and which is larger than 0° and smaller than 15°. A sloping angle larger than 0° has the consequence that the vertical (perpendicular to the vat bottom) distance of the lower edge to the vat bottom increases from a minimal distance at the point closest to the rotational axis in radial direction and increases with increasing radial distance to the rotational axis.

The doctor blade may comprise a planar doctor blade which defines a plane which is oriented in an angle of inclination with respect to the vat bottom, which angle of inclination is between 0° and 90°. Preferably the planar doctor blade is inclined with respect to the vat bottom, wherein the angle of inclination is preferably in the range between 30° and 75° and is defined relative to the direction of movement between vat bottom and doctor blade such that the lower edge of the doctor blade is trailing, in the direction of the relative movement, behind the upper edge of the doctor blade.

Alternatively to the relative rotational movement of vat and doctor blade the relative movement of vat and doctor blade can also be effected by a linear shifting of the vat or linear shifting of the doctor blade. In such embodiments it is preferred that the positioning of the doctor blade above the vat bottom is defined by a straight line coinciding with the lower edge of the doctor blade, which straight line is running in constant distance and parallel to the vat bottom.

It may be useful to adapt building material and vat bottom surface with respect to the interfacial tension in order to ensure that the entire vat bottom is wetted with building material without voids, and thus the building material is coating the vat bottom all over. This can be achieved by setting the surface tension of the building material using additives such as defoaming agents or surfactants and/or by modifying the surface of the vat bottom, for example by silanizing.

In a preferred embodiment the surface of the smoothed, thin layer is, in an intermediate step before lowering the building platform and before the location-dependent exposure, colored by position-dependent application of selected coloring agents.

Preferably the coloring agents for adapting the color and the translucency of the part depend on the actually used building material as follows:
a) in case of photopolymers as building material: solutions including dye molecules and/or suspensions including pigments,
b) in case of slurries including glass ceramics as building material: color pigments, in particular oxide, tin oxide or zirconium oxide, dispersed in an organic medium,
c) in case of ZrO₂ slurries as building material: solutions of salts of nitrate (aqueous solutions or on the basis of another solvent) or acetyl acetonate dissolved in ethanol.

In a preferred embodiment the coloring agents are dissolved and/or dispersed in an ink, and are applied onto the smoothed layer by an ink jet printing method.

In a preferred embodiment the coloring agents are light-curing or thermally curing, and are, after spatially selective application to the smoothed layer, fixed by electromagnetic radiation, wherein the electromagnetic radiation used for fixing is outside of the absorption spectrum of the photoinitiator of the building material.

In a preferred embodiment a doctor blade made of polytetrafluorethylene is used, and for the circumferential side wall of the vat a side wall made of polytetrafluorethylene is used.

As vat bottom preferably a disk made of glass or polymethyl methacrylate (PMMA) is used on which on its surface facing the vat bottom an ethylene tetrafluoroethylene film is bonded.

### BRIEF DESCRIPTION OF THE DRAWINGS

The invention will now be described with reference to embodiments in the drawings in which:

FIG. 1 shows a schematic, perspective view of components of an apparatus for carrying out a method according to the present invention;

FIGS. 2A, 2B, 2C and 2D show schematic top views of an apparatus for carrying out a method according to the present invention as a sequence of four subsequent steps during performance of the method according to the invention;

FIG. 3A, 3B, 3C and 3D show corresponding top views as a sequence of four subsequent steps during performance of the method according to the invention;

FIG. 4 shows a detailed view in cross-section through a vat bottom and a doctor blade of an apparatus for performing the method according to the invention;

FIG. 5A is a plan view, partially in cross-section, from the plane A-A of FIG. 4 of the vat bottom and the doctor blade;

FIG. 5B is a top plan view of FIG. 4;

FIGS. 6A and 6B show corresponding views of FIGS. 5A and 5B for an alternative embodiment for effecting a relative movement between doctor blade and vat;

FIG. 7 shows a cross-sectional view of a portion of the vat bottom with a smoothed building material layer on top of it;

FIG. 8 shows a cross-sectional view corresponding to FIG. 7, wherein the portion of the vat bottom has been moved into a position below an ink jet printer;

FIG. 9 shows a cross-sectional view corresponding to FIG. 7, wherein the portion of the vat bottom has already left the area of the ink jet printer and is in a state of movement towards a building area in which above the vat a building platform is disposed and below the vat bottom an exposure unit is disposed;

FIG. 10 is a cross-sectional view corresponding to FIG. 7, wherein the portion of the vat bottom here has been moved to the building region below the building platform;

FIG. 11 is a cross-sectional view corresponding to FIG. 10 after lowering the building platform and during exposure of the defined layer of building material with coloring agents applied; and

FIG. 12 is a cross-sectional view corresponding to FIGS. 10 and 11 after completion of the exposure and raising the building platform.

### DETAILED DESCRIPTION

FIG. 1 shows a schematic, highly simplified perspective view of the essential components of an apparatus for carrying out a method according to the invention. The apparatus comprises a rotatable vat 2, which is for reasons of simplification shown as a vat bottom 3 in the form a circular disk without a sidewall which is actually surrounding the circular disk. The vat bottom 3 is transparent at least in the region in which an exposure unit 6 can expose a building area. Opposite to the exposure unit 6 a vertically movable building platform 8 is disposed above the vat bottom 2. A part 10 under construction is hanging on the building platform 8.

A doctor blade 4 is suspended in adjustable positioning above the vat bottom 3. The vat 2 is rotatable about a vertically extending axis of rotation which is extending from the center of the circular disk of the horizontal vat bottom 3. A rotary drive (not shown) is provided which under the control of a control unit (not shown) rotates the vat 2 and stops the vat in positions determined by the control unit. In a direction opposite to the rotational direction of the vat 2 which is indicated by the arrow a dispensing device for viscous building material (not shown in FIG. 1) is disposed upstream of the doctor blade 4 which dispensing device dispenses viscous building material. This may for example be a cartridge from which a driven piston may deliver building material through an output spout. Due to the rotation of the vat 2 building material is accumulating before the doctor blade 4. Due to the rotation of the vat 2 part of the dispensed building material is moved underneath and past the doctor blade 4 to thereby form a smoothed layer 20 with the predetermined, uniform layer thickness determined by the positioning of the doctor blade 4 with respect to the vat bottom 3.

Displaced by about 90° in circumferential direction with respect to the doctor blade 4 an ink jet printer 12 is moveably supported above the vat 2. The ink jet printer 12 is used, after stopping the rotation of the vat 2, to apply to a predetermined region of the smoothed layer 20 coloring agents in a spatially selective manner, in order to obtain a desired location-dependent coloring for the layer next to be solidified.

After completion of the printing process by the ink jet printer 12 the vat 2 is rotated further by 90° so that the area of the smoothed layer 20 to which coloring agents have been applied by the ink jet printer is moved to the region between the exposure unit 6 and the building platform 8. Then, the building platform 8 is, under control of the control unit, lowered with respect to the surface of the vat bottom 3 to such an extent that the lower surface of the building platform (in case of the first layer to be solidified on the building platform) or the lower surface of the last cured layer of the part 10 being built is at a distance to the vat bottom which is equal to the predetermined layer thickness, such that building material is displaced from the gap and a remaining layer having a predefined layer thickness is created. According to the invention the positioning of the doctor blade 4 above the vat bottom 3 is set in such a manner that the smoothed layer 20 is already close to and as appropriate only marginally above the predefined layer thickness. For this purpose the positioning of the doctor blade with respect to the vat bottom is adjusted such that after passing the doctor blade the resulting predetermined, uniform layer thickness is in the range of 100% to 150% of the predefined layer thickness to be set by lowering the building platform. As has been explained above there are several advantages if the amount of building material to be displaced during setting the layer thickness by lowering the building platform is small, ideally negligibly small.

After setting the predefined layer thickness by controlled lowering of the building platform relative to the vat bottom the layer of building material imprinted with coloring agents defined in the gap is exposed by the exposure unit 6 through the vat bottom in a spatially selective manner and is thereby solidified. Thereafter, the building platform is, with the part 10 being built hanging thereon, raised such that the currently solidified layer is disengaged from the vat bottom 3 and is lifted up.

The operation of the ink jet printer 12 and of the exposure unit 6 is controlled by a control unit (not shown) in which the three-dimensional shape data of the shaped body to be built up is stored, in particular also as data of the contour shapes of the individual layers to be successively solidified and of the distribution of coloring agents in the area of the respective layers to be solidified.

FIGS. 2A, 2B, 2C and 2D show a sequence of method steps in schematic plan views from above on an apparatus such as shown in FIG. 1, wherein the sequence illustrates a series of four working steps during the performance of the method according to the invention. In the first step which is illustrated at the left edge in FIG. 2A the vat is rotated counter-clockwise about the vertical axis of rotation perpendicular to the vat bottom 3. At the same time building material, for example photopolymerizable material filled with particulate ceramic material, is dispensed, for example from a cartridge, in rotational direction upstream of the doctor blade 4 onto the vat bottom so that a certain tailback of building material 18 develops at the doctor blade 4. Due to the rotation of the vat bottom 3 building material is moved underneath the doctor blade 4 and past the doctor blade, wherein the doctor blade 4 is suspended in adjustable positioning above the vat bottom, so that by the lower edge of the doctor blade a smoothed layer 20 is formed having a predetermined, uniform layer thickness determined by the positioning of the doctor blade 4 with respect to the vat bottom 3. The smoothed layer 20 is moved by the rotation of the vat to an area below the ink jet printer 12 which is shifted by 90° with respect to the doctor blade 4 in counter-clockwise direction. As soon as the region of the smoothed layer 20 which later on will be the building area for solidifying a further layer, has reached the area below the ink jet printer 12, the vat is stopped. In this phase the layer of building material is imprinted with coloring agents in a spatially selective manner. The result of the application of the coloring agents is schematically shown in the second view from the left in FIG. 2B, in which the printed letters DLP are intended to symbolize the applied coloring agents that have been imprinted in a spatially selective manner (of course, in methods for manufacturing dental products generally no discrete colored structures such as letters are applied but rather continuously varying colorings). The movable suspension of the ink jet printer 12 is indicated by the crossed arrows, wherein the ink jet printer is moved in a controlled manner controlled by the control unit (not shown) to realize the spatially selective application of colorings in the building region.

Thereafter the vat is again rotated by 90° in counter-clockwise direction and is then stopped again, wherein this state is shown in the second view from the right in FIG. 2C. Due to this rotation the region to which in the preceding steps coloring agents have been applied, symbolized by DLP, reaches the exposure unit 6 opposite to the doctor blade 4 and is there, after lowering the building platform for setting the predefined layer thickness, solidified in a spatially selective manner by exposure. This is indicated in FIG. 2C by the grid opposite to the doctor blade 4, which grid indicates picture elements (pixels) of the exposure unit. (The building platform is omitted in the view of FIGS. 2A-2D so that the building area below the building platform remains visible). Simultaneously with the exposure a following building area of the wet building material layer in the 6 o'clock position is imprinted with coloring agents which are against symbolized by DLP. During phases of rotation the doctor blade 4 continues to form a smoothed layer 20 with the predetermined, uniform layer thickness. It is noted again that in the views of FIGS. 2A-2D for reasons of illustration the building platform which is actually disposed over the exposure unit above the vat bottom has been omitted so that the exposure area of the exposure unit is visible.

In the transition to the state shown on the right edge of FIG. 2D a further 90° rotation of the vat bottom 3 took place, wherein doctor blade 4 continued to continuously form a smoothed layer 20 having the predetermined, uniform layer thickness. After the 90° rotation and stopping the rotation of the vat bottom the ink jet printer 12 is again applying coloring agents in the next building area, while the building area that was previously imprinted with coloring agents in FIG. 2C now is in the region of the exposure unit in the 3 o'clock position in FIG. 2D and is, after lowering of the building platform (not shown), exposed. In this example it is assumed that the area corresponding to the letters DLP is exposed and solidified.

The area DLP exposed in FIG. 2C has been rotated in the subsequent method step shown in FIG. 2D to the 12 o'clock position and is shown there as an area with the letter sequence DLP in which the vat bottom is visible, because after solidification of this area the building platform has been raised again, whereby, since the building platform is not shown in FIGS. 2A-2D, the remaining negative image of the solidified layer in the layer 20 remained, i.e. after raising the building platform together with the just solidified layer in the shape of the letter sequence DLP this area remains as negative image or void in the layer 20.

FIGS. 3A-3D show a sequence of method stages corresponding to FIGS. 2A-2D during performance of a method according to the invention, wherein the apparatus for carrying this method differs in the following points from the apparatus illustrated in FIGS. 2A-2D. In FIGS. 3A-3D a building material dispensing device 30 is shown which was not shown in FIG. 2A-2D, wherein this building material dispensing device comprises two cartridges with different building materials. The cartridges are connected to a common mixing device which prepares a selected mixture of building materials and dispenses the mixture. The doctor blade 4 in this case is configured as a double or twin doctor blade, i.e., it comprises two parallel doctor blades between which a cavity is formed which is open at the bottom. The building material is delivered by the mixing device directly to the cavity between the two doctor blades. The positioning of the doctor blade which is downstream with respect to the direction of rotation is again set such that a smoothed layer 20 having a predetermined, uniform layer thickness determined by the positioning of the doctor blade 4 with respect to the vat bottom is formed.

In the 12 o'clock position a vacuum doctor blade 34 is mounted which is likewise formed as a double or twin doctor blade having a cavity in-between which is open at the bottom. The cavity of the vacuum doctor blade 34 is kept under negative pressure such that remaining building material left behind after the exposure step in the 3 o'clock position and lifting off the building platform is sucked away.

With reference to FIGS. 4, 5A and 5B, an embodiment of the adjustable doctor blade for forming the smoothed layer 20 is described, which layer 20 has a predetermined, uniform layer thickness determined by the positioning of the doctor blade 4 with respect to the vat bottom. In the view in FIG. 5B, a schematic plan view of the vat bottom 3 from above is shown. The longitudinal direction of the doctor blade 4 extends here from a starting point close to the rotational axis of the circular vat bottom 3 radially in outward direction to an end point close to the outer circumference of the circular vat bottom 3. In FIG. 4 a cross-sectional view of part of the vat bottom 3 and of the doctor blade 4 is shown, wherein the plane of the cross-section is perpendicular to the radial longitudinal extension of the doctor blade 4 visible in FIG. 5A. As can be seen in the view of FIG. 4 the blade of the doctor blade 4 is not oriented perpendicular to the vat bottom 3 but is inclined with respect to the vat bottom 3 forming an inclination angle κ with respect to the vat bottom. The inclination angle is an acute angle, preferably in the angular range from 30° to 75°, wherein the doctor blade 4 is inclined at this inclination angle κ such that the inclination angle is disposed with respect to the direction of relative movement of the doctor blade with respect to the vat bottom such that the lower edge of the doctor blade 4 in the direction of the relative movement of the doctor blade 4 with respect to the vat bottom is trailing behind an upper edge of the doctor blade 4. With reference to FIG. 4 this means that the direction of relative movement of the doctor blade 4 with respect to the vat bottom 3 is directed to the right hand side, wherein then the lower edge of the doctor blade 4 is trailing behind the upper edge during the relative movement of the doctor blade with respect to the vat bottom. In movement direction of the doctor blade 4 relative to the vat bottom 3 in front of the doctor blade 4 building material dispensed on the vat bottom is accumulating. The positioning of the doctor blade with respect to the vat bottom is adjusted such that the portion of the building material which passes the gap between the vat bottom and the lower edge of the doctor blade is formed into a smoothed layer 20 with the predetermined, uniform layer thickness D_{N} as determined by the positioning of the doctor blade with respect to the vat bottom 3. The described inclination angle causes a funnel effect, i.e. building material is, by the relative movement of the inclined doctor blade, urged towards the gap between the lower edge of the doctor blade and the vat bottom.

For the embodiment of the apparatus described here having a rotatable vat 2 and a non-rotating doctor blade 4 it is advantageous to adjust a further angle, which will now be described in connection with FIGS. 5A and 5B. FIG. 5A shows a plan view taken from the plane A-A of FIG. 4, i.e. the viewing direction is in x direction and is directed to the side of the doctor blade 4. The positioning of the doctor blade 4 with respect to the vat bottom is defined by the course of a straight line which coincides with the lower edge of the doctor blade 4. The straight line coinciding with the lower edge of the doctor blade 4 extends essentially in radial direction with respect to the rotatable vat 2, but is not parallel to the surface of the vat bottom 3, but is inclined at a sloping angle α with respect to the surface of the vat bottom, which sloping angle α is larger than 0° and smaller than 15°, such that the distance of the lower edge of the doctor blade 4 to the vat bottom 3 is, starting from a minimal distance, increasing with increasing radial distance from the axis of rotation. The adjustment of such sloping angle α is necessary for a rotating vat since with increasing radial distance from the axis of rotation an increasing amount of building material is needed since with increasing radial distance the area across which the building material is to be distributed is increasing. In other words, the relative velocity of the lower edge of the doctor blade with respect to the vat bottom is a linearly growing function of the radial distance to the axis of rotation so that at greater radial distances correspondingly more building material is needed which is then, because of the relatively higher velocity of the vat bottom with respect to the doctor blade, to be distributed across a greater area. It has been observed that upstream of the doctor blade material is accumulating at the doctor blade along the entire length over which building material is dispensed in the radial range. Furthermore, it was found that in this embodiment comprising a rotating vat also at larger radial distances from the axis of rotation the layer thickness is determined by the distance of the lower edge of the doctor blade to the vat bottom, but that the gap width which depends on the radial distance to the axis of rotation is not equal to the resulting layer thickness which is in the radially outer region of the doctor blade lower than the gap width. Rather, the material properties such as the viscoelasticity of the building material in connection with the surface tension and the adhesion behavior on the vat bottom are responsible for the effect that in areas at larger radial distances the building material is pulled further apart into a thinner layer than determined there by the gap width between the lower edge of the doctor blade and vat bottom. This requires that in case of a change to another building material which differs in terms of viscosity, surface tension and adhesive properties, the positioning of the doctor blade with respect to the vat bottom has to be adapted such that the desired predetermined and uniform layer thickness is resulting in the entire area of the dispensed building material. In this connection it was found that the optimal positioning of the doctor blade with respect to the vat bottom can be found rather quickly when using an adjustable suspension of the doctor blade, which suspension allows to adjust the height and the sloping angle of the lower edge of the doctor blade continuously using actuating drives, to vary the positioning of the doctor blade which allows a quick adaption of the positioning of the doctor blade by varying its positioning until the desired layer is formed.

The predefined layer thickness which is set by lowering the building platform causing displacement of building material, is in typical building processes in the range between 20 μm and 100 μm, the predefined layer thickness may for example be 50 μm. In order to generate a predetermined, uniform layer thickness by the doctor blade which is higher than the predefined layer thickness but not more than 50% higher than the predefined layer thickness, it is necessary to realize an adjustable suspension of the doctor blade which allows to adjust the minimal distance of the lower edge of the doctor blade 4 with respect to the vat bottom 3, and to adjust the two angles described above in connection with FIGS. 4, 5A and 5B in a precise and reproducible manner, without risk that the adjusted positioning changes during operation. This may for example be accomplished using two positioning tables which are configured for adjusting the table position with high precision, and which form a coupled suspension for the doctor blade. The positioning tables are coupled with each other. One of the positioning tables serves to adjust the minimal distance of the lower edge of the doctor blade with respect to the vat bottom and the other one adjusts via a goniometer the sloping angle α (see FIG. 4) of the lower edge of the doctor blade with respect to the vat bottom.

In FIGS. 6A and 6B, an alternative embodiment realizing the relative movement of doctor blade 4 and vat bottom 3 is illustrated. In this case a rectangular vat bottom 3 is used which is shown in FIG. 6B as a plan view from above (view in z direction). In this case the vat is linearly movable in x direction which is indicated by the arrow in FIG. 6B. In FIG. 6A, a plan view of the doctor blade and the vat bottom from the side (viewing direction=x direction) is shown. In this case the doctor blade 4 is suspended such that its lower edge extends parallel to the surface of the vat bottom 3, and that the distance of the lower edge of the doctor blade 4 to the vat bottom 3 is adjustable. In this case the distance from the lower edge of the doctor blade to the vat bottom is everywhere the same since the relative velocity of the lower edge of the doctor blades to the vat bottom is the same everywhere. The distance of the lower edge of the doctor blade to the vat bottom is equal to the predetermined, uniform layer thickness which is to be formed by the doctor blade 4.

As can be seen in FIG. 6B, a tailback 18 of dispensed building material is formed in movement direction of the vat in front of the doctor blade 4, whereas in moving direction behind the doctor blade 4 a smoothed layer 20 with the predetermined, uniform layer thickness has been formed. It was observed that for many types of building material the actually generated layer thickness of the smoothed building behind the doctor blade is not exactly equal to the gap width between the lower edge of the doctor blade and the vat bottom, but the layer thickness is in many cases slightly smaller. In this connection it was also found that by varying the positioning of the lower edge of the doctor blade, for example by means of actuating drives controlled by the control unit, the correct positioning of the doctor blade with respect to the vat bottom can be found quickly, which correct positioning of the doctor blade results in the desired predetermined, uniform layer thickness.

In FIGS. 7-12 another presentation of the sequence of method steps during performance of the method of the invention is shown. FIG. 7 shows a schematic plan view on a portion of the vat bottom 3 on which the doctor blade 4 already formed a smoothed layer 20 with predetermined, uniform layer thickness. This smoothed layer is moved by rotation of the vat to a region below the ink jet printer 12 where rotation of the vat is stopped. This stage is shown in the plan view of FIG. 8 in which the movement and operation of the ink jet printer 12 is illustrated which applies coloring agents 22 in a spatially selective manner. After termination of the operation of the ink jet printer the vat is rotated further, wherein FIG. 9 shows a plan view of the vat during this stage of rotation, wherein the area of the layer 20 is shown which was previously provided with coloring agents. The rotation of the vat is continued until the imprinted layer area reaches the building region between the building platform 8 and the exposure unit. This state is illustrated in FIG. 10. In this step of the method the building platform 8 is lowered by a drive controlled by the control unit, until the distance between the lower surfaces of the last cured layer of the part 10 currently being built to the surface of the vat bottom is equal to the predefined layer thickness. This step is completed in FIG. 11, whereafter the currently defined layer above the vat bottom 3 is solidified in a spatially selective manner by controlled operation of the exposure unit. The layer curing in this manner by exposure is, by the ongoing polymerization, firmly attached to the last previously cured layer, which leads to firm attachment of the two layers, and which leads eventually to a shaped body of layers firmly connected to each other.

After termination of the exposure step the building platform 8 is raised again in FIG. 12 such that the part 10 hanging thereon with the last layer cured before in FIG. 11 is lifted off the vat bottom. Empty regions or holes remain on the vat bottom in the regions of the last cured layer, as can be seen in FIG. 12. These regions are filled up again when the vat is rotated and the empty regions reach the dispensing area of building material in front of the doctor blade.

When choosing the material of the doctor blade, of the vat bottom and of the side wall of the vat the following has to be taken into account. For the doctor blade and the side wall of the vat PTFE (polytetrafluoroethylene) is the most suitable material. Because of its low surface energy PTFE is advantageous for all components which come into direct contact with the building material to be processed. The building materials to be processed in this case does not adhere to the doctor blade or to the side wall of the vat. On the other hand, when using doctor blades of other plastic materials such as polycarbonate or polyamide, empty zones in the coating were observed.

In case situations should arise in which the doctor blade comes into direct contact with the side wall of the vat the excellent slide characteristics of PTFE come into effect so that blocking of the rotating mechanism of the vat generally does not occur. PTFE is chemically inert with respect to solvents, reactive components as well as coloring agents in suspensions. The stiffness of PTFE as well as its resistance to wear against abrasive ceramic suspensions are sufficient so that in experiments no tear and wear effects could be observed.

When choosing the material for the vat bottom two aspects have to be taken into account. First the vat bottom has to have sufficient stiffness. Second, the surface has to be very smooth and planar. Third, the vat bottom surface has to be wettable by the building material suspensions. For this aspect the contact angle and the viscosity of the building material are of importance. These requirements were best fulfilled by a combination of PMMA (polymethyl methacrylate, thickness: 3 mm), and on top of that an ETFE (ethylene tetrafluoroethylene, thickness: 80 μm) film. For the vat bottom instead of PMMA also glass or similar materials can be considered. Restrictions for the material choice for the vat bottom result from the additional requirements regarding transparency for the exposure, and regarding the pull-off forces during the stereolithographic building process. The ETFE film used in connection with the present invention is provided with a self-adhesive side which allows a bubble-free and planar bonding of the ETFE film on the PMMA support disk. A vat bottom formed in this manner which is planar to a high precision is one of the preconditions for forming thin building material layers with high accuracy by means of the doctor blade. As PTFE also ETFE is inert against the chemicals used, which come into contact with the ETFE film. In combination with the building material formulations used in connection with the present invention with ETFE a smaller contact angle, and thus a better wettability, could obtained compared to FEP (fluoroethylenepropylen).

A low contact angle (considered as representing the wettability) correlates well with a thin setting of a layer thickness of the building material layer. If the wettability is not sufficiently good this results in “dissolving” of the building material layer and in “island formation”, since the building material locally contracts or shrinks. Holes are formed in the coating, and possibly droplets are formed. These effects can to a large extent be reduced or be retarded by an increased viscosity of the building material suspension. In experiments it was found that a viscosity between 10 and 50 Pa·s as suitable for a contact angle for typically building materials used between 50° and 60°.

In the method according to the invention the building material layer which is still wet may be imprinted in a spatially selective manner with coloring agents before the building platform is lowered to the layer and the layer is exposed by the exposure unit and is solidified. The coloring agents have to be selected according to the type of the building material, wherein the following assignments are preferred.

For unfilled and filled photopolymers as building material solutions including dye molecules and/or suspensions including pigments can be used.

In case of use of glass ceramic slurries as building material as coloring agents preferably color pigments, in particular oxide, tin oxide or zirconium oxide, dispersed in an organic medium, are used.

In case of ZrO₂ slurries as building material preferably solutions of salts of nitrate (aqueous solutions or on the basis of another solvent) or acetylacetonate dissolved in ethanol is used.

In some embodiments, data is received from a computer that is part of the system. The computer can include a processor and a memory storing computer-readable program code portions that, in response to execution by the processor, cause instructions to be provided to one or more components of the system for carrying out a method described herein. Further, the data representing the surface colorization of the article can be part of an image of the article in a computer readable format, such as a computer assisted design (CAD) format. Other formats may also be used. The data representing the surface colorization may also be provided as a separate image (including a separate image in a computer readable format), separate from an uncolored image of the article. Moreover, it is also possible, in some cases, to receive the data representing the surface colorization of an article from a camera or other image scanner. Surface colorization data may be received in other manners as well, and the scope of the present disclosure is not necessarily limited to a specific manner in which surface colorization data is received. Further, the surface colorization data may be received prior to, simultaneous with, or after one or more rendering or slicing steps are carried out.

In some embodiments, the processor can be a single processor having one or more cores, or a plurality of processors connected by a bus, network, or other data link. The electronic data storage unit can be any form of non-transitory computer-readable storage medium suitable for storing the data produced by the system. The display can be any display suitable for displaying a digital color or grayscale image.

In some embodiments, the processor is in communication over a network, which could be wired or wireless, with an external processor used for performing one or more calculation steps and/or a network-attached electronic data storage unit. In some embodiments, the present disclosure makes use of cloud computing to perform one or more calculations steps remotely and/or remote storage to enable the storage of data remotely for collaborative or remote analysis.

1. Method for building a shaped body by layer-wise solidification of viscous, photopolymerizable building material by means of stereolithography, wherein
a) building material is dispensed onto a planar, transparent bottom of a vat (2),
b) the vat (2) is moved relatively to a blade (4) in a direction parallel to the plane of the vat bottom (3), which blade is suspended with adjustable positioning above the vat bottom (3), such that dispensed building material is moved underneath the blade (4), to thereby form a smoothed layer (20) having uniform layer thickness predetermined by the positioning of the blade (4) relative to the vat bottom (3),
c) the smoothed layer (20) is brought by relative movement of the vat (2) to a region between an exposure unit (6) located underneath the vat bottom (3) and a building platform (8) suspended above the vat adjustable in height,
d) the building platform (8) is lowered relative to the vat bottom in a controlled manner so that, while displacing building material, the remaining layer in the gap is formed into a predefined layer thickness,
e) the layer is solidified in a spatially selective manner by controlled operation of the exposure unit (6) within a contour desired for the current layer,
f) whereafter the building platform (8) is raised, building material is dispensed onto the vat bottom, and steps b) to f) are repeated until the shaped body is build up by a plurality of layers solidified on top of each other,
characterized in that the positioning of the blade (4) with respect to the vat bottom (3) is adjusted in such a manner that the resulting predetermined, uniform layer thickness is higher than the predefined layer thickness to be set by lowering the building platform (8), but does not exceed the predefined layer thickness by more than 50%.

2. Method according to claim 1,
characterized in that the position of the blade (4) relative to the vat bottom (3) is adjusted in such a manner that the resulting predetermined, uniform layer thickness is in the range of 110% to 130% of the predefined layer thickness.

3. Method according to claim 1,
characterized in that the relative movement of the vat (2) and the blade (4) is effected by rotating the vat (2) about a central axis perpendicular to the vat bottom (3) with respect to a blade (4) suspended in a stationary manner or by rotating the blade (4) about the axis mentioned relative to a vat (2) which is stationary.

4. Method according to claim 3,
characterized in that the position of the blade (4) above the vat bottom (3) is defined by a straight line coinciding with a straight lower edge of the blade is defined by a minimal distance to the vat bottom (3) at the point of the lower edge of the blade which is closest to the axis of rotation, and by a sloping angle (α) which is defined by the straight line of the lower edge and a plane parallel to the vat bottom (3) which is intersected by a straight line, which sloping angle is larger than 0° and smaller than 15° so that the distance of the lower edge to the vat bottom (3) increases from the minimal distance with increasing radial distance to the axis of rotation.

5. Method according to claim 4,
characterized in that the blade (4), comprises a planar blade, and that the blade is inclined at an inclination angle (κ) with respect to the vat bottom (3), wherein the inclination angle (κ) which is larger than 0° and lower than 90°, is in the range of 30° to 75°, and the inclination angle is defined in relation to the direction of relative movement between vat bottom (3) and blade (4) in such a manner that the lower edge of the blade (4) in the direction of relative movement of the blade (4) with respect to the vat bottom is trailing behind the upper edge of the blade (4).

6. Method according to claim 1,
characterized in that the relative movement of the vat (2) and the blade (4) is effected by linearly shifting the vat (2) or by linearly shifting the blade (4).

7. Method according to claim 6,
characterized in that the position of the blade (4) above the vat bottom is defined by the run of a straight line coinciding with the lower edge of the blade (4), which straight line runs at a constant distance to and parallel to the vat bottom (3).

8. Method according to claim 1,
characterized in that the surface of the smoothed, thin layer is, in an intermediate step before lowering of the building platform (8) and before spatially selective exposure, colored by applying in a spatially selective manner selected coloring agents.

9. Method according to claim 8,
characterized in that the coloring agents for setting the color and translucence are selected in a manner adapted to the currently used building material:
a) in case of photopolymers as building material: solutions comprising dye molecules and/or suspensions including pigments,
b) in case of slurries comprising glass ceramics as building material: color pigments, oxides, tin oxide or zirconium oxide, dispersed in an organic medium,
c) in case of ZrO₂ slurries as building material: solutions of salts of nitrate comprising aqueous solutions or on the basis of another solvent or acetyl acetonate dissolved in ethanol.

10. Method according to claim 8,
characterized in that the coloring agents are dissolved and/or dispersed in an ink and are applied in a spatially selective manner by an ink jet printer onto the smoothed layer.

11. Method according to claim 8,
characterized in that the coloring agents are light-curing or thermally curing and are, after spatially selective application onto the smoothed layer, fixed by electromagnetic radiation, wherein the electromagnetic radiation used for fixation is outside of the absorption spectrum of the photo initiator of the building material.

12. Method according to claim 1,
characterized in that the blade is made of polytetrafluoroethylene and a circumferential side wall of the vat (2) is made of polytetrafluoroethylene.

13. Method according to claim 1,
characterized in that the vat bottom (3) is a pane of glass or polymethyl methacrylate onto which the vat bottom surface facing the vat bottom, an ethylene tetrafluoroethylene film is bonded.
